(19) United States
(12) Patent Application Publication
(10) Pub. No.: US 2016/0060470 A1
(43) Pub. Date: Mar. 3, 2016

(54) METHOD OF REFURBISHING AN ELECTRONIC DEVICE COMPONENT

(71) Applicant: INNOVATIVE FINISHES LLC, Granby, CT (US)

(72) Inventor: Jeffrey J. Bliss, Granby, CT (US)

(73) Assignee: Innovative Finishes LLC, Granby, CT (US)

(21) Appl. No.: 14/786,704

(22) PCT Filed: Apr. 22, 2014
(86) PCT No.: PCT/US2014/034991

§ 371 Date: Oct. 23, 2015

Related U.S. Application Data
(60) Provisional application No. 61/817,988, filed on May 1, 2013.

(51) Int. Cl. C09D 7/12; C03C 15/02; B05D 3/10; B05D 5/08; B05D 5/00; B05D 7/00; C09D 201/06; C03C 17/32

(52) U.S. Cl. CPC C09D 7/1266; C09D 201/06; C03C 15/02; C03C 17/32; B05D 5/08; B05D 5/00; B05D 7/52; B05D 3/104; C08K 3/22

(57) ABSTRACT

A method of refurbishing a surface of a component for an electronic device, includes: contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the secondly cleaned surface with an activator to provide an activated surface; disposing a coating resin on the treated and optionally activated surface; and curing the coating resin to provide a coated surface to refurbish the surface of the electronic device, wherein the coating resin comprises a by droxyl functional dendritic polymer; optionally an acrylic polyol; and a plurality of metal oxide nanoparticles optionally encapsulated in a hydroxyl functional polymer or a hydroxyl functional fluorosurfactant.

### BACKGROUND

(1) Field

This disclosure relates to a refurbished component, an electronic device including the same, and method of refurbishing a component of an electronic device.

(2) Description of the Related Art

Electronic devices, such as cell phones or touch pads, can get scratched or worn in the course of use. Devices without visible scratches are desirable because they have higher resale value and are cosmetically attractive. Scratched or worn components can be replaced with new components. However, refurbishing is desirable to reduce cost and environmental impact. Thus there remains a need for a method of refurbishing device components to provide a suitable cosmetic appearance.

### SUMMARY

Disclosed is a method of refurbishing a surface of a component for an electronic device, the method including: contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the secondly cleaned surface with an activator to provide an activated surface; disposing a coating resin on the treated and optionally activated surface; and curing the coating resin to provide a coated surface to refurbish the surface of the electronic device, wherein the coating resin comprises: a hydroxyl functional dendritic polymer; optionally an acrylic polyol; and a plurality of metal oxide nanoparticles optionally encapsulated in a hydroxyl functional polymer or a hydroxyl functional fluoro surfactant.

Also disclosed is a method of refurbishing a surface, the method including: contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the secondly cleaned surface with an activator to provide an activated surface; disposing a coating resin on the treated and optionally activated surface; and curing the coating resin to provide a coated surface to refurbish the surface, wherein the coating resin comprises: a hydroxyl functional dendritic polymer; optionally an acrylic polyol; and a plurality of metal oxide nanoparticles optionally encapsulated in a hydroxyl functional polymer or a hydroxyl functional fluorosurfactant.

Also disclosed is a method of refurbishing a surface of a component for an electronic device, the method including: contacting a surface to be refurbished by applying an etching composition to the surface, allowing the etching composition to reside for about 2 seconds to about 30 minutes, removing the etching composition and a coating from the surface to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; contacting the secondly cleaned surface with an activator to provide an activated surface; and disposing a coating resin on the treated and activated surface; and curing the coating resin to provide a coated surface to refurbish the surface of the electronic device, wherein the coating resin comprises a first resin and a second resin, the first resin comprises a clear coat, a hardener, and a reducer, wherein the clear coat comprises a hydroxyl-functional binder selected from a polyurethane, a (meth)acrylic copolymer, a polyester, a polyether, or a combination comprising at least one of the foregoing polymer; the hardener comprises a polyisocyanate crosslinker; and the reducer comprises a solvent; and the second resin comprises a first component and a second component, wherein the first component comprises: hydroxyl functional dendritic polymer; optionally an acrylic polyol; and a plurality of metal oxide nanoparticles optionally encapsulated in a hydroxyl functional polymer or a hydroxyl functional fluorosurfactant; and the second component comprises a cross-linking agent selected from a polyisocyanate, a melamine formaldehyde resin, and a combination comprising at least one of the foregoing compound, and wherein the surface comprises glass.

Also disclosed is a refurbished component for an electronic device including a surface and a polymerization product of a first resin and a second resin, wherein the first resin comprises a clear coat and a hardener, the clear coat comprises a hydroxyl-functional binder selected from a polyurethane, a (meth)acrylic copolymer, a polyester, a polyether, or a combination comprising at least one of the foregoing polymer; and the hardener comprises a polyisocyanate crosslinker; and wherein the second resin comprises a first component and a second component, the first component comprises: a hydroxyl functional dendritic polymer; optionally an acrylic polyol; and a plurality of metal oxide nanoparticles optionally encapsulated in a hydroxyl functional polymer or a hydroxyl functional fluorosurfactant; and the second component comprises a cross-linking agent selected from a polyisocyanate, a melamine formaldehyde resin, and a combination comprising at least one of the foregoing compound.

Also disclosed is a refurbished component for an electronic device including a surface and a polymerization product of a resin having a first component and a second component, wherein the first component comprises: a hydroxyl functional dendritic polymer having a hydroxyl functionality of 40 to 80; a plurality of metal oxide nanoparticles optionally encapsulated in a hydroxyl functional polymer or a hydroxyl functional fluorosurfactant; and a hydroxyl-functional binder selected from a polyurethane, a (meth)acrylic copolymer, a polyester, a polyether, or a combination comprising at least one of the foregoing polymer, wherein the hydroxyl-functional binder has a hydroxyl functionality of 2 to 25; and wherein the second component comprises a cross-linking agent selected from a polyisocyanate, a melamine formaldehyde resin, and a combination comprising at least one of the foregoing compound.

Also disclosed is a refurbished electronic device, the electronic device including the refurbished component for the electronic device.

### DETAILED DESCRIPTION

The invention now will be described more fully hereinafter. This invention may be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Alkoxy” means an alkyl group that is linked via an oxygen (i.e., —O—alkyl). Nonlimiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups.

“Alkyl” means a straight or branched chain saturated aliphatic hydrocarbon having the specified number of carbon atoms, specifically 1 to 12 carbon atoms, more specifically 1 to 6 carbon atoms.

“Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof

“Amino” has the general formula —N(R)₂, wherein each R is independently hydrogen, a C1 to C6 alkyl, or a C6 to C12 aryl.

“Epoxy” means a functional group comprising an oxygen atom joined by single bonds to two adjacent carbon atoms forming a three-membered ring.

“Halogen” means one of the elements of Group 17 of the periodic table (e.g., fluorine, chlorine, bromine, iodine, and astatine).

“Carboxyl” means a functional group consisting of a carbonyl and a hydroxyl, which has the formula —C(═O)OH.

“NCO functionality” means the average number of isocyanate groups on a molecule.

“Hydroxyl functionality” means the average number of hydroxyl groups on a molecule.

“Surface to be refurbished” includes damaged surface as well as undamaged surface.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

There is currently no technology, including buffing, which can remove deep scratches on the glass surfaces of device screens or digitizers. Further, buffing does not result in a cosmetically satisfactory product having a sufficiently scratch-free appearance and suitable luster. Also, modern wireless devices use high hardness glasses and/or coatings which make buffing difficult. In addition, clear coatings do not suitably adhere directly to device screens or digitizers, making it impractical to simply cover scratched surfaces with a clear coating.

After exploring different process and material variables, it has been surprisingly discovered that the scratched, worn and lackluster glass surfaces of device screens or digitizers can be refurbished conveniently in a cost-effective matter to provide a scratch-free and shiny new appearance using the method disclosed herein. In addition, the refurbished surface can have high scratch resistance, high chemical resistance, long-term weather resistance, and excellent gloss retention. Accordingly, by refurbishing electronic devices using the discovered method, the worn devices can have a cosmetically appealing new look, and also have a surface coating that is effective to provide long term protection to the device surface, thereby preserving the environment, conserving materials, minimizing pollution, and eliminating waste.

Disclosed is a method of refurbishing a surface of a component of an electronic device, e.g., a surface of a wireless device screen or a digitizer, which provides a surface that is free of scratches or defects to the untrained and unaided eye, e.g., an eye of a consumer.

In an embodiment, the method comprises contacting a surface to be refurbished with an etching composition to remove a coating from the surface and provide a treated surface; disposing a coating resin on the treated surface; and curing the coating resin to provide a coated surface to refurbish the surface of the component of the electronic device.

The contacting may comprise applying the etching composition to the surface to be refurbished, allowing the etching composition to reside for about 2 seconds to about 30 minutes, specifically about 5 seconds to about 20 minutes, more specifically about 10 seconds to about 15 minutes, or about 15 seconds to about 10 minutes, and then removing the etching composition and the coating.

The etching composition can comprise a fluoride selected from sodium fluoride, potassium fluoride, ammonium fluoride, sodium bifluoride, potassium bifluoride, ammonium bifluoride, ammonium borofluoride, ammonium silicofluoride, or a combination thereof. The fluoride can be present in an amount of about 1 weight percent (wt %) to about 50 wt %, specifically about 5 wt % to about 40 wt %, more specifically about 5 wt % to about 30 wt %, about 5 to about 20 wt %, about 10 wt % to about 50 wt %, or about 15 wt % to about 40 wt % based on the total weight of the etching composition.

The etching composition can further comprise an acid selected from acetic acid, citric acid, malic acid, succinic acid, phosphoric acid, hydrochloric acid, sulfuric acid, nitric acid, hydrofluoric acid, or a combination thereof. The amount of the acid component can be about 0.1 wt % to about 20 wt %, specifically about 0.5 wt % to about 15 wt %, more specifically from about 2 wt % to about 10 wt %, about 5 wt % to about 20 wt %, or about 5 wt % to about 15 wt %, based on the total weight of the etching composition.

The etching composition can be in the form of a paste, a cream, a gel or a liquid.

The method may further comprise abrading the surface to be refurbished with an abrasive to remove a coating on the surface and provide an abraded surface. The abrading may comprise abrading with a diamond polishing compound. The diamond polishing compound comprises diamond and a lubricant and/or a vehicle. The diamond may have a mesh of about 600 to about 2000 grit, specifically about 800 to about 1800 grit. A diamond polishing compound comprising 1200 grit diamond is specifically mentioned. In an embodiment the diamond has a maximum particle size of about 1 micrometer (μm) to about 15 μm, specifically about 2 μm to about 10 μm. Diamond having a maximum particle size of about 9 μm is specifically mentioned.

The abrading may comprise abrading with aluminum oxide particles having a size of 5 to 80 micrometers, for example, about 5 to about 30 micrometers, about 15 to about 45 micrometers, or about 30 to about 80 micrometers using an abrasive jet machining (“AJM”) system. The AJM system can operate at a pressure of about 0.5 bar to about 100 bar, specifically about 1 bar to 30 bar, more specifically about 3 bar to about 10 bar. The aluminum oxide particles are carried by air or an inert gas such as nitrogen and argon. An exemplary AJM system that may be used is a micro-blaster.

The abrading may be sufficient to remove a coating on the surface to be refurbished. In an embodiment, the surface is an oleophilic surface. In another embodiment, the surface is an oleophobic surface.

The method may further optionally comprise after the removing, optionally firstly cleaning the abraded or treated surface by contacting with a glass cleaner to provide a firstly cleaned surface; optionally secondly cleaning the firstly cleaned surface by contacting the firstly cleaned surface with a grease remover to provide a secondly cleaned surface; and optionally contacting the secondly cleaned surface with an activator to provide an activated surface.

As used herein, “removing a coating” includes partially removing the coating. While not wanting to be bound by theory, it is understood that complete removal of the coating is desirable in some embodiments in order to provide a refurbished surface having suitable cosmetic properties, for example, a surface which is optically scratch free and has desirable luster.

After removing the coating, the abraded or treated surface may be optionally contacted with a glass cleaner to provide a firstly cleaned surface. The glass cleaner may comprise a solvent, a cleaning agent, a surfactant, a wetting agent, or a combination thereof. The glass cleaner may also comprise a fragrance or a dye. In a specific embodiment, the glass cleaner comprises water and acetic acid. In another embodiment, the glass cleaner comprises ammonium hydroxide instead of acetic acid. The glass cleaner can also comprises disodium cocoamphodipropionate, 2-hexoxyethanol, butoxypropanol, butoxyethanol, isopropyl alcohol, propylene glycol, sodium lauryl sulfate, ethoxylated alcohol, sodium C₁₄₋₁₇ sec-alkyl sulfonate, sodium laureth sulfate, lauryl glucoside, alkyl polyglycoside, sodium dodecylbenzene sulfonate, ethanol amine, or a combination thereof.

Also, the abraded surface may be further optionally contacted with a grease remover to provide a secondly cleaned surface. The grease remover may comprise a solvent effective to remove grease. Exemplary solvent includes acetone, an alcohol (e.g., methanol, ethanol, butanol); water; liquid carbon dioxide; an aldehyde (e.g., an acetaldehyde, a propionaldehyde), a formamide (e.g., N, N-dimethylformamide); a ketone (e.g., acetone, methyl ethyl ketone, β-bromoethyl isopropyl ketone); acetonitrile; a sulfoxide (e.g., dimethylsulfoxide, diphenylsulfoxide, ethyl phenyl sulfoxide); a sulfone (e.g., diethyl sulfone, phenyl 7-quinolylsulfone); a thiophene (e.g., thiophene 1-oxide); an acetate (e.g., ethylene glycol diacetate, n-hexyl acetate, 2-ethylhexyl acetate); an amide (e.g., propanamide, benzamide), or a combination thereof. In an embodiment, the grease remover comprises stoddard solvent such as mineral spirits, aliphatic petroleum distillates, white spirits; naphtha; heptane; toluene; or a combination thereof.

The treated surface, which may optionally be firstly cleaned and/or secondly cleaned, may be optionally contacted with an activator to provide an activated surface. While not wanting to be bound by theory, it is understood that the activator chemically reacts with the treated surface to provide a functional group thereon to provide improved bonding properties with a coating layer. The activator may comprise an alcohol, e.g., methanol, ethanol, propanol, isopropanol, butanol, or a combination thereof, and/or a silane compound. In an embodiment, the activator comprises a carboxysilyl compound of the formula SiR₁R₂R₃R₄ wherein R₁ is a straight or branched chain substituted with a carboxyl group or a salt thereof, each R₂, R₃ and R₄ is independently a C1 to C12 alkoxy group, a C1 to C12 alkyl group, a C6 to C24 aryl group, halogen, or hydroxy. The phrase “straight or branched chain” as used herein means a C1 to C12 hydrocarbon optionally substituted with a heteroatom such as N on its backbone. An exemplary carboxysilyl compound is N-[(3-trimethoxysilyl)propyl]ethylene-diamine triacetic acid trisodium salt. The activator may comprise an activator as disclosed in U.S. Pat. No. 8,293,322, the content of which in its entirety is herein incorporated by reference, e.g., 2-oxo-N-(3-(triethoxysilyl)propyl)azepane-1-carboxamide. The activator may comprise a silica sol comprising a metal salt and a partial hydrolyzate of an alkoxysilane oligomer, wherein the metal salt is a metal organic acid salt or a metal carbonate of one or more of magnesium, calcium, strontium and barium, and wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane or aminopropyltriethoxysilane. Such activators are disclosed in European Patent Application EP1304399, the content of which in its entirety is herein incorporated by reference. In an embodiment, the activator may comprise an unsaturated-hydrocarbylamido-alkanesulfonic acid or a salt thereof, e.g., 2-acrylamido-2-methylpropanesulfonic acid or a salt thereof, as disclosed in European Patent EP 1560858, the content of which in its entirety is herein incorporated by reference. The activator may comprise an epoxysilane for example a gamma glycidoxy-propyl-trimethoxy-silane.

In an embodiment, the activator may also comprise a reaction product of an epoxy silane and an amino silane having at least two amine groups per molecule. The epoxy silane and amino silane are used in amounts such that the final mole ratio of epoxy silanes to amino silanes in the reaction mixture is about at least 2:1. Suitable epoxy silanes for use in preparing a reaction product with epoxy silane and amino silane include any compound containing at least one epoxy group and silane group per compound and include, for example, gamma-glycidoxypropyldimethylethoxy silane, gamma-glycidoxypropylmethyldiethoxy silane, gamma-glycidoxypropyltrimethoxy silane, glycidoxypropyltrimethoxy silane, beta-(3,4-epoxycyclohexyl)ethylmethyltrimethoxy silane, and beta-(3,4-epoxycyclohexyl)ethylmethyldimethoxy silane. Specifically mentioned is gamma-glycidoxypropyltrimethoxy silane. Suitable amino silanes include N-(beta-aminoethyl)aminomethyltrimethoxy silane, gamma-aminopropyltriethoxy silane, gamma-aminopropylmethyldiethoxy silane, N-(gamma-aminoethyl)-gamma-aminopropyltriethoxy silane, N-(gamma-aminoethyl)-gamma-methyldimethoxy silane, and trimethoxysilylpropyldiethylene triamine. N-beta-(aminoethyl)-gamma-aminopropyltrimethoxy silane is specifically mentioned. The activator may also comprise a film forming resin. Such activators are disclosed in U.S. Pat. No. 5,466,727, the content of which in its entirety is herein incorporated by reference.

The activator may be disposed by any suitable method, e.g., spraying, dipping, roll coating, brush coating, or transfer coating.

A coating resin, i.e., a coating composition comprising a resin or a clear coat, is then disposed on the treated (or abraded) and optionally activated surface of the component. A wide variety of clear-coat formulations are known and can be used. However, particularly advantageous coating resins comprise a first resin and a second resin that co-cure to provide a coating with exceptional properties, for example fast cure for efficient manufacture, and suitable buffability and hardness.

In an embodiment, the coating resin comprises a first resin and a second resin. The first and second resin may each independently comprise a blend of a polymer, copolymer, terpolymer, or a combination comprising at least one of the foregoing polymers.

The polymer, copolymer, terpolymer, or a combination can be an oligomer, a homopolymer, a copolymer, a block copolymer, an alternating block copolymer, a random polymer, a random copolymer, a random block copolymer, a graft copolymer, a star block copolymer, a dendrimer, or the like, or a combination thereof.

Examples of polymers which may be included in the first and/or the second resin include thermoplastic and thermosetting polymers such as polyacetals, polyolefins, polyacrylics, polyacrylates, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyethylene terephthalate, polybutylene terephthalate, polyurethane, ethylene propylene diene rubber (EPR), polytetrafluoroethylene, fluorinated ethylene propylene, perfluoroalkoxyethylene, polychlorotrifluoroethylene, polyvinylidene fluoride, or the like, or a combination thereof.

The first and second resins may be a blend comprising thermoplastic polymers, and may include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like, or a combination thereof.

In an embodiment, the first and second resin may each independently comprise a polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydioxoisoindoline, polytriazine, polypyridazine, polypiperazine, polypyridine, polypiperidine, polytriazole, polypyrazole, polypyrrolidine, polycarborane, polyoxabicyclononane, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurea, polyphosphazene, polysilazane, or a combination thereof.

The first and second resins are curable resins, for example polyacrylics, polyacrylates, epoxies, phenolics, and polyurethane precursors, in particular polyurethane prepolymers. Such resins are often used in combination with hardeners, for example polyisocyanate or polyurethane prepolymers containing isocyanate groups. The prepolymers can then be reacted with monomers, oligomers, or polymers containing active hydrogen groups, for example hydroxyl and amino groups. These oligomers or polymers can be polyesters, polyacrylics, or polyacrylates. Curing agents can further be included, for example short-chain diamines and glycols such 1,4-butanediol. If desired, a catalyst can be included to promote the reaction between the isocyanate groups and the hydroxyl or amino groups.

In an embodiment, the first resin comprises a clear coat, a hardener, and optionally a reducer. A content of the clear coat may be about 0.1 to about 6 parts, specifically about 1 part to about 4 parts, based on a total content of the first resin. A content of the hardener may be about 0.1 to about 2 parts, specifically about 0.2 part to about 1.5 parts, based on a total content of the first resin. The reducer, when present, acts to adjust the working viscosity of the composition. A content of the reducer may be about 0 to about 1 part, specifically about 0.01 part to about 0.5 part, based on a total content of the clear coat, the hardener, and the reducer, if present.

The clear coat comprises a hydroxyl-functional binder. The hydroxy-functional binder comprises oligomeric and/or polymeric compounds with a number average molecular weight (Mn) of, e.g., 500 to 500,000 g/mole, specifically of 1100 to 300,000 g/mole and can have a hydroxyl functionality of 2 to 25. The binders with hydroxyl groups are for example the polyurethanes, (meth)acrylic copolymers, polyesters and polyethers, or a combination thereof. Examples of hydroxy-functional polyurethane resins are those, for example, with a number average molecular weight Mn of 500 to 500 000 g/mol, specifically, of 1100 to 300 000 g/mol, more specifically, of 5000 to 300 000 g/mol, an acid value of 0 to 100 mg KOH/g, specifically of 0 to 80 mg KOH/g, a hydroxyl value of 40 to 400 mg KOH/g, specifically, of 80 to 250 mg KOH/g. The polyurethane resins include such resins which are in modified form, for example, as silicon-modified or (meth)acrylated polyurethane resins. Examples of poly(meth)acrylate resins are for example those with a number average molecular mass Mn of 1000-20000 g/mol, specifically, of 1100-15000, an acid value of 0-100 mg KOH/g, specifically, of 0-50 and a hydroxyl value of 40-400 mg KOH/g, specifically, of 60-200 mg KOH/g. The poly(meth)acrylate resins can also have been prepared in the presence of different binders, e.g., in the presence of oligomeric or polymeric polyester and/or polyurethane resins. Examples of hydroxy-functional polyester resins are for example hydroxyfunctional polyesters with a number average molecular weight of 500-10,000 g/mol, specifically, of 1100-8000 g/mol, an acid value of 0-150 mg KOH/g, specifically, of 0-50 mg KOH/g and a hydroxyl value of 40-400 mg KOH/g, specifically, of 50-200 g/mol.

The hardener of the first resin comprises a crosslinker The crosslinkers are polyisocyanates with free isocyanate groups. Examples of polyisocyanates are any number of organic polyisocyanates with aliphatically, cycloaliphatically, araliphatically and/or aromatically bound free isocyanate groups. At 23° C., the polyisocyanates generally have a viscosity of 1 to 6,000 megapascal (MPa), advantageously, above 5 and below 3,000 MPa. Specifically mentioned polyisocyanates are polyisocyanates or polyisocyanate mixtures with exclusively aliphatically and/or cycloaliphatically bound isocyanate groups with an average NCO functionality of 1.5 to 5, specifically 2 to 4. Examples of particularly suitable polyisocyanates are what are known as “paint polyisocyanates” based on hexamethylene diisocyanate (HDI), 1-isocyanato-3,3,5-trimethyl-5-isocyanatomethyl-cyclohexane (IPDI), isophorone diisocyanate, 3-isocyanatomethyl-3,5,5-trimethylcyclohexyl isocyanate, and/or bis(isocyanatocyclohexyl)-methane and the derivatives thereof. As used herein, the “derive” means isocyanates and polyisocyanates modified by introduction of at least one of urethane, allophanate, urea, biuret, carbodiimide, uretonimine, or isocyanurate residues to the above mentioned diisocyanate, which, following production, are freed from surplus parent diisocyanate, for example by distillation, and having a residue content of less than 0.5% by weight. Triisocyanates, such as, triisocyanatononan can also be used. Sterically hindered polyisocyanates are also suitable. Examples of these are 1,1,6,6-tetramethyl-hexamethylene diisocyanate, 1,5-dibutyl-penta-methyldiisocyanate, p- or m-tetramethylxylylene diisocyanate and the appropriate hydrated homologues. In some embodiments, diisocyanates can be converted by the usual method to higher functional compounds, for example, by trimerization or by reaction with water or polyols, such as, for example, trimethylolpropane or glycerine. The polyisocyanates can also be used in the form of isocyanate-modified resins.

The reducer can comprise a paint solvent. Examples of suitable solvents include mono- or polyvalent alcohols, for example propanol, butanol, hexanol; glycol ethers or glycol esters, for example diethylene glycol dialkyl ether, dipropylene glycol dialkyl ether, each with C1 to C6 alkyl, ethoxy propanol, butyl glycol; glycols, for example ethylene glycol, propylene glycol, N-methylpyrrolidone and ketones, for example methyl ethyl ketone, acetone, cyclohexanone; aromatic or aliphatic hydrocarbons, for example toluene, xylene or linear or branched aliphatic C6-C12 hydrocarbons. In a specific embodiment, the reducer comprises butyl acetate, propylene glycol monoethyl ether acetate, propylene glycol methyl ether acetate, 2-methoxy-1-methylethyl acetate, 2-methoxypropyl-1-acetate, acetone, xylene, toluene, or a combination thereof.

The first resin can also comprise low molecular reactive components, so-called reactive thinners, which are able to react with the crosslinker.

The first resin may also contain an additive. Examples of additives include light stabilizers, for example based on benztriazoles and hindered amine light stabilizer (“HALS”) compounds, flow agents based on (meth)acryl-homopolymers or silicone oils, rheology-influencing agents, such as highly dispersed silica or polymeric urea compounds, thickeners, such as cross linked-on polycarboxylic acid or polyurethanes, anti-foaming agents, wetting agents, curing accelerators, for example for the crosslinking reaction of OH-functional binders with the polyisocyanate crosslinkers, for example organic metallic salts, such as dibutyl tin dilaurate, zinc naphthenate and compounds containing tertiary amino groups, such as triethylamine. The selection and the quantity of the additive can be determined by a person of ordinary skill in the art without undue experimentation.

In an embodiment, the first resin is provided as a multiple package system. For example, the first resin can comprise a clear coat in a first package, a hardener in a second package, and optionally a reducer in a third package. The reducer can also be included in the first package or the second package. Shortly before use, the clear coat, the hardener and the optional reducer can be mixed to provide the first resin.

The second resin can comprise a first component and a second component. The first component comprises a hydroxyl functional dendritic polymer; optionally, an acrylic polyol; and a plurality of metal oxide nanoparticles optionally encapsulated in a hydroxyl functional polymer and/or a hydroxyl functional fluorosurfactant. The first component can comprise a catalyst and a first solvent in which the materials of the first component other than the solvent are either dissolved or dispersed. The first component can optionally comprise a sterically hindered amine light stabilizer; and optionally, a UV absorber. The second component comprises a cross-linking agent, and a second solvent which may be the same as or different from the first solvent.

The dendritic polymer is a dendritic polyester having a hydroxyl functionality of from about 20 to about 100, specifically about 30 to about 80, more specifically about 40 to about 80, or from about 35 to about 65. The molecular weight of the dendritic polyester can be from about 5,000 to about 10,000 Daltons. A highly-branched polyester having a hydroxyl functionality of 64 is specifically mentioned.

In an embodiment, the dendritic polymer further comprises a carboxyl functional group. The carboxyl functional group can be introduced into the dendritic polymer by reacting hydroxyl functional groups on the dendritic polymer with a dicarboxylic acid or an anhydride of a dicarboxylic acid, for example, maleic anhydride and succinic anhydride. In an embodiment, the molar ratio of the hydroxyl groups relative to the carboxyl groups on the dendritic polymer is greater than about 1:1. In an embodiment, the ratio is about 1:1 to about 20:1.

In some embodiments, the first component of the second resin can also comprise an acrylic polyol having a hydroxyl functionality of from 2 to 6. Addition of the acrylic polyol tends to reduce the hardness and brittleness of the coating composition.

Nanoparticles are not particularly limited. In an embodiment, the nanoparticles are metal oxides. Examples of the nanoparticles include, without limitation, aluminum oxide (Al₂O₃) and/or zinc oxide (ZnO) nanoparticles. Aluminum oxide nanoparticles can have a particle size in the range of about 10 to about 500 nanometers, specifically about 20 to about 60 nanometers. Similarly, the zinc oxide nanoparticles can have a particle size in the range of about 10 to about 500 nm, specifically from about 50 to about 70 nanometers.

Optionally, the aluminum and zinc nanoparticles are encapsulated in a polymer. The polymer advantageously exhibits high adhesion to the nanoparticle and can be a hydroxyl functional silicone polyacrylate such as, without limitation, BYK SILCLEAN 3700*. The encapsulated aluminum oxide and/or zinc oxide nanoparticles increase scratch resistance, improve hydrophobicity, and enhance the self-cleaning surface properties of the coating.

In an embodiment, the first component of the second resin also contains a hydroxyl functional fluorocarbon, in particular a hydroxyl functional fluorinated methacrylate polymer such as, without limitation, ZONYL 8857A* fluorosurfactant from DuPont.

Optionally, a hindered amine light stabilizer (HALS) can be included in the first component of the second resin. HALS are known to those skilled in the art as efficient stabilizers against light-induced degradation of polymers. A presently preferred HALS is TINUVIN 292*.

A UV absorber can also optionally be included in the first component of the second resin, an example, without limitation, of which is hydroxyphenylbenzotriazole, commercially available as TINUVIN 1130*.

The second component of the second resin comprises a cross-linking agent polyisocyanate, which can react with hydroxyl groups to form urethanes. Another cross-linking agent that may be used is a melamine formaldehyde resin, which can react with hydroxyl groups to form acetals. An exemplary melamine formaldehyde resin includes hexamethoxymethyl-melamine formaldehyde resin.

The polyisocyanate cross-linking agent having an average isocyanate functionality of from 1.5 to 5. It can be the same or different from the crosslinker in the hardener of the first resin described herein. A specifically mentioned polyisocyanate is polymeric hexamethylene diisocyanate available as DESMODUR N-3300*. A dibutyltin catalyst can be used to speed the cure time.

A content of each of the first component and the second component of the second resin may independently be about 0.5 to about 1.5 parts, specifically about 0.7 to about 1.4 parts, based a total content of the first component and the second component.

An exemplary embodiment of the second resin is disclosed in U.S. Pat. No. 8,206,827, the content of which in its entirety is herein incorporated by reference.

Optionally, the second resin can further comprise a reactive diluent selected from 1,3-cyclohexane dimethanol, 1,4-cyclohexane dimethanol or a combination thereof. The weight ratio of the dendritic polymer to the reactive diluent can be from about 1:50 to about 1:2, from about 1:40 to about 1:3, from about 1:35 to about 1:4, from about 1:30 to about 1:5.

It has been found that a coating using the first resin alone would not provide suitable hardness, and a coating using the second resin alone would not provide suitable buffing properties. Surprisingly, when the coating resin comprises both the first resin and the second resin, the surface of a component for an electronic device can be suitably refurbished to provide scratch free and cosmetically-appealing appearance.

The coating resin may comprise the first resin in an amount of about 1 to about 99 wt %, specifically about 10 to about 90 wt %, more specifically about 20 to about 80 wt %, based on a total weight of the coating resin. The coating resin may comprise the second resin in an amount of about 1 to about 99 wt% , specifically about 10 to about 90 wt %, more specifically about 20 to about 80 wt %, based on a total weight of the coating resin. An embodiment comprising equal parts of the first and second resin is specifically mentioned.

The coating resin is described herein in detail as comprising a first resin and a second resin, wherein the first resin comprises a clear coat, a hardener, and optionally a reducer, and the second resin comprises a first component and a second component. However, it is appreciated that it is also within the scope of the disclosure when the coating resin comprises a first component and a second component, wherein the first component of the coating resin comprises (i) the clear coat of the first resin or the hydroxyl-functional binder of the clear coat in the first resin; and (ii) the first component of the second resin; and wherein the second component of the coating resin comprises the hardener of the first component and/or the second component of the second resin.

In addition to the first resin and the second resin, the coating resin can further comprise a silane. In an embodiment, the silane has the general structure: Z₃—Si—(CH₂)ₙ—X wherein each Z is independently a halide, a hydroxide or an alkoxy group; X is an amino group, a hydroxyl group, or an epoxy; and n is an integer from 1 to 10. In an embodiment, Z is chloride, methoxy, or ethoxy. In another embodiment, the organosilane compound is a monofunctional trimethoxysilyl epoxysilane, wherein X is epoxy and Z is methoxy. Exemplary silane compounds include beta-(3,4-epoxycyclohexyl)ethyltrimethoxysilane and gamma-glycidoxypropyltrimethoxysilane.

The silane compound may be present in an amount of at least about 0.01% by weight based on the total weight of the resin composition. In other embodiments, the silane compound may be used in an amount from about 0.01% to about 50% by weight, 0.01% to about 40% by weight, 0.01% to about 30% by weight, 0.01% to about 20% by weight, 0.01% to about 10% by weight, based on the total weight of the resin composition.

Advantageously, the silane may help to improve the adhesion properties of a coating formed from the resin. In particular, the silane compound may improve the ability of the formed coating to adhere to glass. Further advantageously, the silane compound may also act as cross-linkers to promote cross-linking between the dendritic polymers, thereby increasing the cross-linking density. As a result, the formed coatings may exhibit improved hardness, and chemical and moisture resistance.

The coating resin can be disposed on the abraded or treated and optionally activated surface by means known to a person skilled in the art, for example, by spraying, brushing, dipping, or brushing. Once deposited, the coating resin can be cured to provide a coated surface to refurbish the surface of the electronic device.

The curing may include heating the coating resin. The heating may include convection heating, microwave heating, or infra-red heating. The heating may comprise heating at about 30° C. to about 80° C., specifically at about 35° C. to about 70° C.

Depending on the curing conditions and the specific formulation of the coating resin, the curing time may vary from a few minutes to a few hours. Specifically, the curing time is 5 to 180 minutes.

The surface to be refurbished can comprise glass or other materials suitable for use as a screen or in the surface of an electronic device component. Advantageously, the surface to be refurbished comprises glass. In an embodiment, the surface comprises alkali aluminosilicate. Corning Gorilla glass is specifically mentioned.

Also disclosed is a method of refurbishing a digitizer for an electronic device, the method comprising the foregoing method for refurbishing a surface.

Also disclosed is a refurbished component for an electronic device, the refurbished component comprising: a polymerization product of a first resin and a second resin, wherein the first resin comprises a clear coat and a hardener, the clear coat comprises a hydroxyl-functional binder selected from a polyurethane, a (meth)acrylic copolymer, a polyester, a polyether, or a combination comprising at least one of the foregoing polymer; and the hardener comprises a polyisocyanate crosslinker; and wherein the second resin comprises a first component and a second component, the first component comprises: a hydroxyl functional dendritic polymer; optionally an acrylic polyol; and a plurality of metal oxide nanoparticles optionally encapsulated in a hydroxyl functional polymer or a hydroxyl functional fluorosurfactant; and the second component comprises a cross-linking agent selected from a polyisocyanate, a melamine ormaldehyde resin, and a combination comprising at least one of the foregoing compound.

In an embodiment, the polymerization product is directly disposed on the surface of the component for an electronic device. In another embodiment, the refurbished component may further comprise an activation layer disposed between the polymerization product and the component surface of the electronic device. The electronic device may be a wireless device. The component may be a screen, a digitizer, a front case, or a rear case, for example.

Also disclosed is refurbished electronic device, the electronic device comprising a component comprising: a substrate; and a polymerization product of a first resin and a second resin directly on the substrate, wherein the first resin and the second resin are as disclosed herein.

The disclosed embodiment is further described by way of the following Examples. The Examples are illustrative and shall not limit the scope of this disclosure.

### PROPHETIC EXAMPLE

A digitizer of an Apple iPhone will be provided. The surface of the digitizer will be etched using Armour Etch glass etching cream. The etched digitizer will then firstly be cleaned using a glass cleaner (Windex*), secondly cleaned using a degreaser (Klean Strip* Prep-A11*), and dry wiped to remove residual degreaser.

The cleaned surface will then treated with an activator (Glassprimer GP083).

The activated surface will then sprayed with a coating resin prepared by combining equal parts of a first resin and a second resin. The first resin will be prepared by mixing 1 part hardener (Spies Hecker Permasolid* 3220), 0.1 part reducer (Spies Hecker Permacron* 3363), and 3 parts clearcoat (Spies Hecker Permasolid* 8600). The second resin will be prepared using 1 part of a clear coat (Nanovere VX-RC 2K) and 1 part activator (Nanovere).

The coating resin will be allowed to cure at room temperature to provide a refurbished surface.

A method of refurbishing a surface of a component for an electronic device comprises contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the secondly cleaned surface with an activator to provide an activated surface; disposing a coating resin on the treated and optionally activated surface; and curing the coating resin to provide a coated surface to refurbish the surface of the electronic device, wherein the coating resin comprises a hydroxyl functional dendritic polymer; optionally an acrylic polyol; and a plurality of metal oxide nanoparticles optionally encapsulated in a hydroxyl functional polymer or a hydroxyl functional fluorosurfactant.

In various embodiments, (i) the removing comprises: applying an etching composition to the surface to be refurbished; allowing the etching composition to reside for about 2 seconds to about 30 minutes; and removing the etching composition and a coating from the surface; (ii) the etching composition comprises a fluoride selected from sodium fluoride, potassium fluoride, ammonium fluoride, sodium bifluoride, potassium bifluoride, ammonium bifluoride, ammonium borofluoride, ammonium silicofluride, or a combination thereof; (iii) the etching composition further comprises an acid selected from acetic acid, citric acid, malic acid, succinic acid, phosphoric acid, hydrochloric acid, sulfuric acid, nitric acid, hydrofluoric acid, or a combination thereof; (iv) the fluoride is present in an amount of about 1 wt % to about 50 wt % and the acid is present in an amount of about 0.1 wt % to about 20 wt %, all based on the total weight of the etching composition; and/or (v) the etching composition is selected from a paste, a cream, a gel or a liquid.

The coating resin can comprise a first resin and a second resin, wherein the second resin comprises a first component comprising the hydroxyl functional dendritic polymer, the optional acrylic polyol and the plurality of metal oxide nanoparticles; and the first resin comprises a clear coat and a hardener, wherein the clear coat comprises a hydroxyl-functional binder selected from a polyurethane, a (meth)acrylic copolymer, a polyester, a polyether, or a combination comprising at least one of the foregoing polymer; and the hardener comprises a polyisocyanate crosslinker.

Further, in various embodiments, (i) the coating is an oleophilic coating or an oleophobic coating; (ii) the glass cleaner comprises water and acetic acid; (iii) the grease remover comprises acetone, an alcohol; liquid carbon dioxide; an aldehyde; a formamide; a ketone; acetonitrile; a sulfoxide; a sulfone; a thiophene; an acetate; an amide; or a combination thereof; (iv) the grease remover comprises mineral spirits, aliphatic petroleum distillates, white spirits, naphtha, heptane, toluene or a combination thereof; (v) the activator comprises a silane; (vi) the activator comprises a reaction product of an epoxy silane and an amino silane having at least two amino groups; (vii) the activator comprises a carboxysilyl compound of the formula SiRᵢR₂R₃R₄ wherein R₁ is a straight or branched chain substituted with a carboxyl group or a salt thereof, each R₂, R₃ and R₄ is independently a C1 to C12 alkoxy group, a C1 to C12 alkyl group, a C6 to C24 aryl group, halogen, or hydroxyl; (viii) the activator comprises N-[(3-trimethoxysilyl)propyl]ethylene-diamine triacetic acid trisodium salt; (ix) the activator comprises 2-oxo-N-(3-(triethoxysilyl)propyl)azepane-1-carboxamide; (x) the activator comprises a silica sol comprising a metal salt and a partial hydrolyzate of an alkoxysilane oligomer, wherein the metal salt is a metal organic acid salt or a metal carbonate of one or more of magnesium, calcium, strontium and barium, and wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane or aminopropyltriethoxysilane; (xi) the activator comprises an unsaturated-hydrocarbylamido-alkanesulfonic acid or a salt thereof; and/or (xii) the contacting comprises spraying, dipping, roll coating, brush coating, or transfer coating.

In another embodiment, refurbished component for an electronic device comprises a surface, and a polymerization product of a first resin and a second resin disposed on the surface, wherein the first resin comprises a clear coat and a hardener, the clear coat comprises a hydroxyl-functional binder selected from a polyurethane, a (meth)acrylic copolymer, a polyester, a polyether, or a combination comprising at least one of the foregoing polymer; and the hardener comprises a polyisocyanate crosslinker; and wherein the second resin comprises a first component and a second component, the first component comprises: a hydroxyl functional dendritic polymer; optionally an acrylic polyol; and a plurality of metal oxide nanoparticles optionally encapsulated in a hydroxyl functional polymer or a hydroxyl functional fluorosurfactant; and the second component comprises a cross-linking agent selected from a polyisocyanate, a melamine formaldehyde resin, and a combination comprising at least one of the foregoing compound.

In yet another embodiment, a refurbished component for an electronic device comprises a surface and a polymerization product of a resin having a first component and a second component disposed on the surface, wherein the first component comprises: a hydroxyl functional dendritic polymer having a hydroxyl functionality of 40 to 80; a plurality of metal oxide nanoparticles optionally encapsulated in a hydroxyl functional polymer or a hydroxyl functional fluorosurfactant; and a hydroxyl-functional binder selected from a polyurethane, a (meth)acrylic copolymer, a polyester, a polyether, or a combination comprising at least one of the foregoing polymer, wherein the hydroxyl-functional binder has a hydroxyl functionality of 2 to 25; and wherein the second component comprises a cross-linking agent selected from a polyisocyanate, a melamine formaldehyde resin, and a combination comprising at least one of the foregoing compound.

In various embodiments, regarding the coating resin used in the method of refurbishing or the refurbished component, (i) the hydroxyl functional dendritic polymer has a hydroxyl functionality of 40 to 80; (ii) the hydroxyl functional dendritic polymer is a branched polyester having a hydroxyl functionality of 64; (iii) the hydroxyl functional dendritic polymer further comprises a carboxyl group; (iv) the acrylic polyol has a hydroxyl functionality of 2 to 6; (v) the plurality of encapsulated metal oxide nanoparticles is selected from encapsulated aluminum oxide nanoparticles, encapsulated zinc oxide nanoparticles or a combination comprising at least one of the foregoing particles; (vi) the hydroxyl functional polymer is a hydroxyl functional silicone polyacrylate; (vii) the hydroxyl functional fluorosurfactant is a hydroxyl functional fluorinated methacrylate polymer; (viii) the hydroxyl-functional binder has an acid value of 0 to 100 mg KOH/g, and a hydroxyl value of 40 to 400 mg KOH/g; (ix) the polyisocyanate crosslinker has an average NCO functionality of 1.5 to 5; (x) the polyisocyanate crosslinker is selected from hexamethylene diisocyanate, isophorone diisocyanate, 3-isocyanatomethyl-3,5,5-trimethylcyclohexyl isocyanate, 1-isocyanato-3,3,5-trimethyl-5-isocyanatomethyl-cyclohexane, bis(isocyanatocyclohexyl)-methane, a derivative of one of the foregoing, or a combination thereof; (xi) the first resin further comprises a reducer comprising butyl acetate, propylene glycol monoethyl ether acetate, propylene glycol methyl ether acetate, 2-methoxy-1-methylethyl acetate, 2-methoxypropyl-1-acetate, acetone, xylene, toluene, a combination comprising at least one of the foregoing; (xii) the coating resin further comprises a silane of the formula Z₃—Si—(CH₂)ₙ-X wherein each Z is independently a halide, a hydroxyl or an alkoxy group; X is an amino, a hydroxyl, or an epoxy; and n is an integer from 1 to 10; (xiii) the polymerization product is disposed directly on the surface; (xiv) the refurbished component further comprises an activation layer disposed between the surface and the polymerization product; (xv) the electronic device is a wireless device; and/or (xvi) the component is a screen, a digitizer, a front case, or a rear case.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of refurbishing a surface of a component for an electronic device, the method comprising:
contacting a surface to be refurbished with an etching composition to provide a treated surface;
optionally firstly cleaning the treated surface by contacting with a glass cleaner to provide a firstly cleaned surface;
optionally secondly cleaning the firstly cleaned surface by contacting the firstly cleaned surface with a grease remover to provide a secondly cleaned surface;
optionally contacting the secondly cleaned surface with an activator to provide an activated surface;
disposing a coating resin on the treated and optionally activated surface; and
curing the coating resin to provide a coated surface to refurbish the surface of the electronic device,
wherein the coating resin comprises
a hydroxyl functional dendritic polymer;
optionally an acrylic polyol; and
a plurality of metal oxide nanoparticles optionally encapsulated in a hydroxyl functional polymer or a hydroxyl functional fluorosurfactant.

2. The method of claim 1, wherein the removing comprises:
applying an etching composition to the surface to be refurbished;
allowing the etching composition to reside for about 2 seconds to about 30 minutes; and
removing the etching composition and a coating from the surface.

3. The method of claim 2, wherein the etching composition comprises a fluoride selected from sodium fluoride, potassium fluoride, ammonium fluoride, sodium bifluoride, potassium bifluoride, ammonium bifluoride, ammonium borofluoride, ammonium silicofluride, or a combination thereof.

4. The method of claim 3, wherein the etching composition further comprises an acid selected from acetic acid, citric acid, malic acid, succinic acid, phosphoric acid, hydrochloric acid, sulfuric acid, nitric acid, hydrofluoric acid, or a combination thereof.

5. The method of claim 3, wherein the fluoride is present in an amount of about 1 wt % to about 50 wt % and the acid is present in an amount of about 0.1 wt % to about 20 wt %, each based on the total weight of the etching composition.

6. The method of claim 2, wherein the etching composition is selected from a paste, a cream, a gel or a liquid.

7. The method of claim 2, wherein the coating is an oleophobic coating.

8. The method of claim 2, wherein the coating is an oleophilic coating.

9. (canceled)

10. (canceled)

11. (canceled)

12. The method of claim 1, wherein the activator comprises a silane.

13. The method of claim 12, wherein the activator comprises a reaction product of an epoxy silane and an amino silane having at least two amino groups.

14. The method of claim 12, wherein the activator comprises a carboxysilyl compound of the formula SiR₁R₂R₃R₄ wherein R₁ is a straight or branched chain substituted with a carboxyl group or a salt thereof, each R₂, R₃ and R₄ is independently a C1 to C12 alkoxy group, a C1 to C12 alkyl group, a C6 to C24 aryl group, halogen, or hydroxy.

15. The method of claim 1, wherein the activator comprises N-[3-trimethoxysilyl)propyl]ethylene-diamine triacetic acid trisodium salt.

16. The method of claim 1, wherein the activator comprises 2-oxo-N-(3-(triethoxysilyl)propyl)azepane-1-carboxamide.

17. The method of claim 1, wherein the activator comprises a silica sol comprising a metal salt and a partial hydrolyzate of an alkoxysilane oligomer, wherein the metal salt is a metal organic acid salt or a metal carbonate of one or more of magnesium, calcium, strontium and barium, and wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane or aminopropyltriethoxysilane.

18. The method of claim 1, wherein the activator comprises an unsaturated-hydrocarbylamido-alkanesulfonic acid or a salt thereof.

19. (canceled)

20. The method of claims claim 1, wherein the coating resin comprises a first resin and a second resin, and wherein the second resin comprises a first component comprising the hydroxyl functional dendritic polymer, the optional acrylic polyol and the plurality of metal oxide nanoparticles.

21. The method of claim 20, wherein the first resin comprises a clear coat and a hardener,
wherein the clear coat comprises a hydroxyl-functional binder selected from a polyurethane, a (meth)acrylic copolymer, a polyester, a polyether, or a combination comprising at least one of the foregoing polymer; and
the hardener comprises a polyisocyanate crosslinker.

22. The method of claim 21, wherein the polyurethane has a number average molecular weight Mn of 500 to 500,000 g/mol, an acid value of 0 to 100 mg KOH/g, and a hydroxyl value of 40 to 400 mg KOH/g.

23. The method of claim 21, wherein the polyurethane comprises silicon-modified or (meth)acrylated polyurethane resins.

24. The method of claim 21, wherein the poly(meth)acrylate resin has a number average molecular mass Mn of 1000 to 20,000 g/mol, an acid value of 0 to 100 mg KOH/g, and a hydroxyl value of 40 to 400 mg KOH/g.

25. The method of claim 21, wherein the polyester has a number average molecular weight of 500 to 10,000 g/mol, an acid value of 0 to 150 mg KOH/g, and a hydroxyl value of 40 to 400 mg KOH/g.

26. The method of claim 21, wherein the polyisocyanate crosslinker has an average NCO functionality of 1.5 to 5.

27. The method of claim 26, wherein the polyisocyanate crosslinker is selected from hexamethylene diisocyanate, isophorone diisocyanate, 3-isocyanatomethyl-3,5,5-trimethylcyclohexyl isocyanate, 1-isocyanato-3,3,5-trimethyl-5-isocyanatomethyl-cyclohexane, bis (isocyanatocyclohexyl)-methane, a derivative of one of the foregoing, or a combination thereof.

28. The method of claim 20, wherein the first resin further comprises a reducer.

29. The method of claim 28, wherein the reducer comprises butyl acetate, propylene glycol monoethyl ether acetate, propylene glycol methyl ether acetate, 2-methoxy-1-methylethyl acetate, 2-methoxypropyl-1-acetate, acetone, xylene, toluene, a combination comprising at least one of the foregoing.

30. The method of claim 20, wherein the second resin further comprises a second component,
wherein the second component comprises a cross-linking agent selected from a polyisocyanate, a melamine formaldehyde resin, and a combination comprising at least one of the foregoing compound.

31. The method of claim 1, wherein the hydroxyl functional dendritic polymer has a hydroxyl functionality of 40 to 80.

32. The method of claim 31, wherein the hydroxyl functional dendritic polymer is a branched polyester having a hydroxyl functionality of 64.

33. The method of claim 32, wherein the hydroxyl functional dendritic polymer further comprises a carboxyl functional group.

34. The method of claim 1, wherein the acrylic polyol has a hydroxyl functionality of 2 to 6.

35. The method of claim 1, wherein the plurality of encapsulated metal oxide nanoparticles is selected from encapsulated aluminum oxide nanoparticles, encapsulated zinc oxide nanoparticles or a combination comprising at least one of the foregoing particles.

36. The method of claim 1, wherein the hydroxyl functional polymer is a hydroxyl functional silicone polyacrylate.

37. The method of claim 1, wherein the hydroxyl functional fluorosurfactant is a hydroxyl functional fluorinated methacrylate polymer.

38. The method of claim 1, wherein the coating resin further comprises
a hydroxyl-functional binder selected from a polyurethane, a (meth)acrylic copolymer, a polyester, a polyether, or a combination comprising at least one of the foregoing polymer, wherein the hydroxyl-functional binder has a hydroxyl functionality of 2 to 25; and
a cross-linking agent selected from a polyisocyanate, a melamine formaldehyde resin, and a combination comprising at least one of the foregoing compounds.

39. The method of claim 38, wherein the plurality of encapsulated metal oxide nanoparticles is selected from encapsulated aluminum oxide nanoparticles, encapsulated zinc oxide nanoparticles or a combination comprising at least one of the foregoing particles.

40. The method of claim 38, wherein the hydroxyl functional fluorosurfactant is a hydroxyl functional fluorinated methacrylate polymer.

41. (canceled)

42. (canceled)

43. The method of claim 1, wherein the coating resin further comprises a silane of the formula Z₃—Si—(CH₂)ₙ-X wherein each Z is independently a halide, a hydroxyl or an alkoxy group; X is an amino, a hydroxyl, or an epoxy; and n is an integer from 1 to 10.

44. (canceled)

45. The method of claim 1, wherein the component is a screen, a digitizer, a front case, or a back case for a wireless device.

46. A method of refurbishing a surface, the method comprising:
contacting a surface to be refurbished with an etching composition to provide a treated surface;
optionally firstly cleaning the treated surface by contacting with a glass cleaner to provide a firstly cleaned surface;
optionally secondly cleaning the firstly cleaned surface by contacting the firstly cleaned surface with a grease remover to provide a secondly cleaned surface;
optionally contacting the secondly cleaned surface with an activator to provide an activated surface;
disposing a coating resin on the treated and optionally activated surface; and
curing the coating resin to provide a coated surface to refurbish the surface,
wherein the coating resin comprises:
a hydroxyl functional dendritic polymer;
optionally an acrylic polyol; and
a plurality of metal oxide nanoparticles optionally encapsulated in a hydroxyl functional polymer or a hydroxyl functional fluorosurfactant.

47. A refurbished component for an electronic device comprising a surface, and a polymerization product of a first resin and a second resin disposed on the surface,
wherein the first resin comprises a clear coat and a hardener, wherein
the clear coat comprises a hydroxyl-functional binder selected from a polyurethane, a (meth)acrylic copolymer, a polyester, a polyether, or a combination comprising at least one of the foregoing polymer, and
the hardener comprises a polyisocyanate crosslinker; and
wherein the second resin comprises a first component and a second component, wherein
the first component comprises
a hydroxyl functional dendritic polymer,
optionally an acrylic polyol, and
a plurality of metal oxide nanoparticles optionally encapsulated in a hydroxyl functional polymer or a hydroxyl functional fluorosurfactant, and
the second component comprises a cross-linking agent selected from a polyisocyanate, a melamine formaldehyde resin, and a combination comprising at least one of the foregoing compounds.

48. The refurbished component of claim 47, wherein the hydroxyl functional dendritic polymer has a hydroxyl functionality of 40 to 80.

49. The refurbished component of claim 48, wherein the hydroxyl functional dendritic polymer is a branched polyester having a hydroxyl functionality of 64.

50. The refurbished component of claim 48, wherein the hydroxyl functional dendritic polymer further comprises a carboxyl group.

51. The refurbished component of claim 47, wherein the first resin further comprises a silane of the formula Z₃—Si—(CH₂)ₙ-X wherein each Z is independently a halide, a hydroxyl or an alkoxy group; X is an amino, a hydroxyl, or an epoxy; and n is an integer from 1 to 10.

52. The refurbished component of claim 47, wherein the acrylic polyol has a hydroxyl functionality of 2 to 6.

53. (canceled)

54. (canceled)

55. (canceled)

56. The refurbished component of claim 47, wherein the hydroxyl-functional binder has an acid value of 0 to 100 mg KOH/g, and a hydroxyl value of 40 to 400 mg KOH/g.

57. (canceled)

58. The refurbished component of claim 47, wherein the polyisocyanate crosslinker is selected from hexamethylene diisocyanate, isophorone diisocyanate, 3-isocyanatomethyl-3,5,5-trimethylcyclohexyl isocyanate, 1-isocyanato-3,3,5-trimethyl-5-isocyanatomethyl-cyclohexane, bis(isocyanatocyclohexyl)-methane, a derivative of one of the foregoing, or a combination thereof.

59. The refurbished component of claim 47, wherein the first resin further comprises a reducer comprising butyl acetate, propylene glycol monoethyl ether acetate, propylene glycol methyl ether acetate, 2-methoxy-1-methylethyl acetate, 2-methoxypropyl-1-acetate, acetone, xylene, toluene, a combination comprising at least one of the foregoing.

60. The refurbished component of claim 47, wherein the polymerization product is disposed directly on the surface.

61. The refurbished component of claim 47, further comprising an activation layer disposed between the surface and the polymerization product.

62. The refurbished component of claim 47, wherein the electronic device is a wireless device.

63. The refurbished component of claim 47, wherein the component is a screen, a digitizer, a front case, or a rear case.

64. A refurbished component for an electronic device comprising a surface and a polymerization product of a resin having a first component and a second component disposed on the surface,
wherein the first component comprises:
a hydroxyl functional dendritic polymer having a hydroxyl functionality of 40 to 80;
a plurality of metal oxide nanoparticles optionally encapsulated in a hydroxyl functional polymer or a hydroxyl functional fluorosurfactant; and
a hydroxyl-functional binder selected from a polyurethane, a (meth)acrylic copolymer, a polyester, a polyether, or a combination comprising at least one of the foregoing polymer, wherein the hydroxyl-functional binder has a hydroxyl functionality of 2 to 25; and
wherein the second component comprises a cross-linking agent selected from a polyisocyanate, a melamine formaldehyde resin, and a combination comprising at least one of the foregoing compounds.

65. (canceled)

66. The refurbished component of claim 64, wherein the hydroxyl functional fluorosurfactant is a hydroxyl functional fluorinated methacrylate polymer.

67. The refurbished component of claim 64, wherein the polyisocyanate crosslinker has an average NCO functionality of 1.5 to 5.

68. The refurbished component of claim 64, wherein the polyisocyanate crosslinker is selected from hexamethylene diisocyanate, isophorone diisocyanate, 3-isocyanatomethyl-3,5,5-trimethylcyclohexyl isocyanate, 1-isocyanato-3,3,5-trimethyl-5-isocyanatomethyl-cyclohexane, bis(isocyanatocyclohexyl)-methane, a derivative of at least one of the foregoing, or a combination thereof.

69. The refurbished component of claim 64, wherein the polymerization product is directly disposed on the surface.

70. The refurbished component of claim 64, further comprising an activation layer disposed between the surface and the polymerization product.

71. (canceled)

72. (canceled)

73. A refurbished electronic device comprising the refurbished component of claim 64.

74. A method of refurbishing a surface of a component for an electronic device, the method comprising:
contacting a surface to be refurbished by applying an etching composition to the surface;
allowing the etching composition to reside for 2 seconds to 30 minutes; removing the etching composition and a coating from the surface to provide a treated surface;
optionally firstly cleaning the treated surface by contacting with a glass cleaner to provide a firstly cleaned surface;
optionally secondly cleaning the firstly cleaned surface by contacting the firstly cleaned surface with a grease remover to provide a secondly cleaned surface;
contacting the secondly cleaned surface with an activator to provide an activated surface; and
disposing a coating resin on the treated and activated surface; and
curing the coating resin to provide a coated surface to refurbish the surface of the electronic device,
wherein the coating resin comprises a first resin and a second resin, the first resin comprising a clear coat, a hardener, and a reducer,
wherein the clear coat comprises a hydroxyl-functional binder selected from a polyurethane, a (meth)acrylic copolymer, a polyester, a polyether, or a combination comprising at least one of the foregoing polymers;
the hardener comprises a polyisocyanate crosslinker; and
the reducer comprises a solvent; and
the second resin comprises a first component and a second component,
wherein the first component comprises:
a hydroxyl functional dendritic polymer;
optionally an acrylic polyol; and
a plurality of metal oxide nanoparticles optionally encapsulated in a hydroxyl functional polymer or a hydroxyl functional fluorosurfactant; and
the second component comprises a cross-linking agent selected from a polyisocyanate, a melamine formaldehyde resin, and a combination comprising at least one of the foregoing compounds, and
wherein the surface comprises glass.
